(19) United States
(12) Patent Application Publication
(10) Pub. No.: US 2022/0251463 A1
(43) Pub. Date: Aug. 11, 2022

(54) REDUCTION OF POLLUTANT EMISSIONS OF INTERNAL COMBUSTION ENGINES

(71) Applicants: Thorsten Kief, Frankenthal (DE); Horst Kief, Bad Dürkheim (DE)

(72) Inventors: Thorsten Kief, Frankenthal (DE); Horst Kief, Bad Dürkheim (DE)

(21) Appl. No.: 17/611,986

(22) PCT Filed: May 17, 2019
(86) PCT No.: PCT/EP2019/062776

§ 371 Date: Nov. 17, 2021

(51) Int. Cl. C10L 1/198; C10L 10/02; C10L 1/12; F02B 47/02; F01P 3/02; F02M 25/03

(52) U.S. Cl. CPC C10L 1/1983; C10L 10/02; C10L 1/125; F02B 47/02; C10L 2290/46; F02M 25/03; C10L 2290/141; C10L 2230/22; C10L 2270/026; F01P 3/02

(57) ABSTRACT

Method for reducing the pollutant emissions of internal combustion engines, wherein an aqueous solution containing glyoxal and a polymer product of citric acid and glycerol is added as an additive, additive for reducing the pollutant emissions of internal combustion engines, said additive consisting of an aqueous solution containing glyoxal and a polymer product of citric acid and glycerol, and the use thereof for reducing pollutant emissions.

The present invention relates to a method for reducing the pollutant emissions from combustion engines, an additive with which the pollutant emissions can be reduced, and its use for reducing pollutant emissions.

Along with the clear evidence of climate change as a result of increased warming, caused, among other things, by CO₂ emissions when oxidising fossil fuels, the environment is being further burdened by particulates and very fine dust from diesel engines, as well as by nitrogen oxides. The reduction of these pollutants by particle filters demonstrates the significance of the harmful emissions. The ideal way would be the complete combustion of fossil fuels directly in the energy extraction process and not the subsequent removal in exhaust gas. The advantage would be not only in the reduction of the harmful emissions, but also in the additional energy extraction and thus reduction of fuel consumption and thus finally also the reduction of CO₂ emissions.

Solutions to this problem have already been demonstrated in a variety of ways. For example, WO 00/17290 A1 describes glyoxal or its acetals or hemiacetals as a fuel additive. However, long-term observations showed that the reproducibility of the results disclosed therein were liable to relatively stark variations and, moreover, injection pumps suffered damages as a result of phase separation which occurred after only weeks in some cases. Here, the phase separation occurred not only with the aqueous phase of the glyoxal in connection with the emulsifiers used there, but also with the acetals used, which is initially surprising since acetals are generally thought to be soluble in hydrocarbons. Thus, the method was not useful despite clear successes in terms of pollutant emission.

In WO 2010/112158 A1, citric acid esters are described as propellant replacement or additive, which are said to achieve a reduced soot formation. Yet the reduction of pollutant emissions is not disclosed in an exactly reproducible manner. The use of citric acid esters as propellant replacement or as additive in the amount of 10% that is seen to be effective might only be enforceable with difficulty for reasons of cost.

It is thus an object to reduce pollutant emissions. Surprisingly, it has now been found that the supply of an additive containing a polymer product of citric acids and glycerine, i.e. a branched polyester, into the combustion chamber of an engine drastically reduces pollutant emissions.

The object above is thus solved by a method for decreasing pollutant emissions in combustion engines, in which an aqueous solution containing a polymer product of citric acid and glycerine is supplied into the combustion chamber of the engine as an additive. The object is also solved by an additive for reducing the pollutant emissions of combustion engines, said additive consisting of an aqueous solution of a polymer product of citric acid and glycerine as well as glyoxal, and by the use of polymer product of citric acid and glycerine for reducing the pollutant emissions. In a preferred embodiment, the polymer product of citric acid and glycerine, abbreviated citric acid polymerisate, is combined with aqueous glyoxal either by glyoxal being contained in the additive and/or aqueous glyoxal solution also being supplied.

The method thus proposes the use of citric acid polymerisate or a combination of citric acid polymerisate and glyoxal in aqueous solution for reducing the pollutant emissions from combustion engines. The additive can be both suctioned via the suction tract and also injected directly into the combustion chamber. The important difference from the fuel additives proposed up until now lies in the fact that the substances are no longer supplied to the fuel in advance.

Here, diesel and petrol engines are above all meant by combustion engine, but also all other engines, e.g. turbines, which are operated by burning hydrocarbons and/or their substitutes such as biodiesel.

The polymer product of citric acid and glycerine is significantly advantageous for injection pumps since it has a high viscosity and has a gel like consistency. Thus, a conservation of the moveable parts is achieved. The polymerisate itself can be used in any aqueous solution and can thus also be mixed with the aqueous glyoxal solution without difficulty.

A further advantage is that the fuel consumption can be decreased and/or the power can be increased as a result of the more complete combustion.

The method according to the invention also has the advantage that, when injecting into the combustion chamber, the aqueous solution reproduces the cooling effect in the combustion process.

The glyoxal as the radical inductor catalytically accelerates the combustion process. Since aqueous glyoxal solutions are stable, emulsifying additions are unnecessary. By combining the glyoxal with the citric acid polymerisate, values can be obtained in the reduction of the pollutant emissions, which have been unknown up until now.

A further advantage of the invention is that the two components of the additives are inexpensive and easily accessible. Aqueous glyoxal solution is a commercial product. The citric acid polymerisate can be produced from commercially available citric acid without great cost by adding glycerine and heating to 90 to 150° C., e.g. by means of microwaves. Usually, citric acid and glycerine are used in a weight ratio of from 1:1 to 10:1, preferably from 1:1 to 5:1 and in particular of about 2:1. Generally, the conversion of 30 g of citric acid and 15 g of glycerine takes only 1 to 5 minutes with a microwave power of 800 W. One possible structure of the polymerisate is depicted in the following formula 1.

The citric acid polymerisate has the critical catalytic effect as a result of its richness in carbonyl groups; it has a gel like consistency, is hydrophilic and is a good absorber of moisture.

The polymerisate is suitable on its own or as a base substance in the combination citric acid polymerisate-glyoxal solution, especially in the air filter or suction tract, respectively. The citric acid polymerisate moreover has the advantage of being completely non-toxic.

Because of its function as a radical inductor, a direct injection of the aqueous glyoxal solution in quantitively predominant amounts into the combustion chamber is preferred in the event of sudden load changes. Both substances and the method of supplying into the suction tract and into the combustion chamber complement each other and it was also found that they accumulate in terms of their pollutant-reducing effect.

In one embodiment, the additive according to the invention or glyoxal solution is injected directly into the combustion chamber for cooling instead of the water injection that is conventional for high power engines. This takes place by means of the same device. Thus, an aqueous solution of citric acid polymerisate and/or of glyoxal can be supplied into the combustion chamber without any problems at all. No fundamental changes are necessary to the engine.

It is particularly advantageous to supply the additive or citric acid polymerisate to the combustion process in a vapour state, which can take place without great technical effort, for example by means of introduction into the suction tract. By introducing into the suction tract, the additive is also supplied into the combustion chamber of the engine by it being carried along by the suctioned combustion air. In a preferred variant, the introduction takes place by soaking the air filter since the evaporation of the solution is particularly effective as a result of the large surface of the filter, and the technical effort is impressively low. Moreover, the evaporation process can be promoted and regulated by an ultrasonic source.

It is particularly advantageous to combine the supply of the citric acid polymerisate, in particular in vapour form, into the suction tract and the injection of the aqueous additive or glyoxal solution into the combustion chamber. Here, the cooling effect on the combustion process can be increased by increasing the amount of water, for example. Either the same additive or, preferably an additive adapted in the content of glyoxal and citric acid polymerisate, can be used, respectively, in particular also the combination of the supply of citric acid polymerisate into the suction tract and glyoxal solution into the combustion chamber. In a preferred embodiment, a constant addition of citric acid polymerisate or glyoxal citric acid polymerisate solution via the air filter as the catalytic base process is combined with an injection of an aqueous glyoxal or glyoxal citric acid polymerisate solution directly in the combustion chamber controlled depending on the load, and thus it regulates the pollutant emission depending on the load.

It is also conceivable to create a completely separate device for supplying the additive. However, this will only be economical with engine redevelopments; retrospective alterations are generally too expensive. However, there is nothing to say that this is not technically possible.

The added amount of citric acid polymerisate and glyoxal is very variable. However, it has proved expedient when the additive contains glyoxal when directly introduced into the combustion chamber and even consists predominantly of the glyoxal solution. This means the volume ratio of glyoxal to polymer product of citric acid and glycerine should expediently range from 10:1 to 1:1. In contrast, with the introduction into the suction tract, the additive should preferably consist completely or predominantly of the citric acid polymerisate. Accordingly, volume ratios of glyoxal to polymerisate of citric acid and glycerine ranging from 1:1 to 1:10 in the additive are suitable.

Overall, the use of citric acid polymerisate or the additive according to the invention (both components in total) is in the lower per mille range; typically 0.1-2 per mille based on the fuel is sufficient, 0.5 to 1 per mille are preferred, based on the volume.

If an addition takes place both directly by means of injection into the combustion chamber and by means of introduction into the suction tract, then glyoxal solution can also be injected, and citric acid polymerisate solution can be applied to the air filter. The addition of the components can thus take place separately in this embodiment.

The invention shall be explained by means of the examples below without being limited to the embodiments specifically described. Unless otherwise stated or necessary from the context, percentages relate to the volume, in case of doubt to the total volume, of the mixture.

The invention also relates to all combinations of preferred embodiments as long as these are not mutually exclusive. The indiction “about” or “approx.” in connection with a number means that values at least 10% higher or lower or values 5% higher or lower and, in any case, values 1% higher or lower are included.

### EXAMPLE 1

To produce the citric acid polymerisate, 30 g citric acid monohydrate was stirred with 15 g glycerine in a glass with the aid of a motorically operated whisk and placed in a conventional domestic microwave (here Koenic KMW 4441 DB model) with a nominal power of 1450 Watt and frequency of 2450 MHz. The mixture was heated for 2 minutes. Here, the formation of steam on the upper glass edge could be observed. After cooling, a clear viscous mass was obtained which could be easily dissolved in water.

### EXAMPLE 2

With a first experiment on a Mini Cooper D, the air filter was soaked with 40 ml of a 50% solution made of citric acid polymerisate and water (PCS), namely before kilometre 106,411 and before kilometre 106,930. In addition, before kilometre 106,943, 20 ml of 40% glyoxal solution (GR) was added in the air filter instead of water. With a 35 l tank capacity, this corresponds to an additive amount of 0.5 per mille of active substance per 1 l fuel before kilometre 106,411 and 0.5 per mille before kilometre 106,930 plus 8 ml glyoxal corresponding to 0.2 per mille per 1 l diesel before kilometre 106,943.

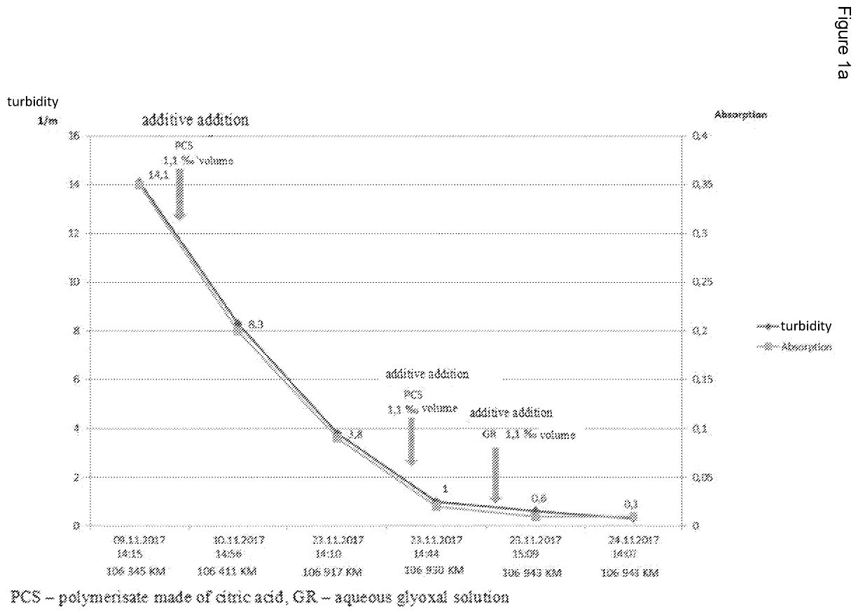

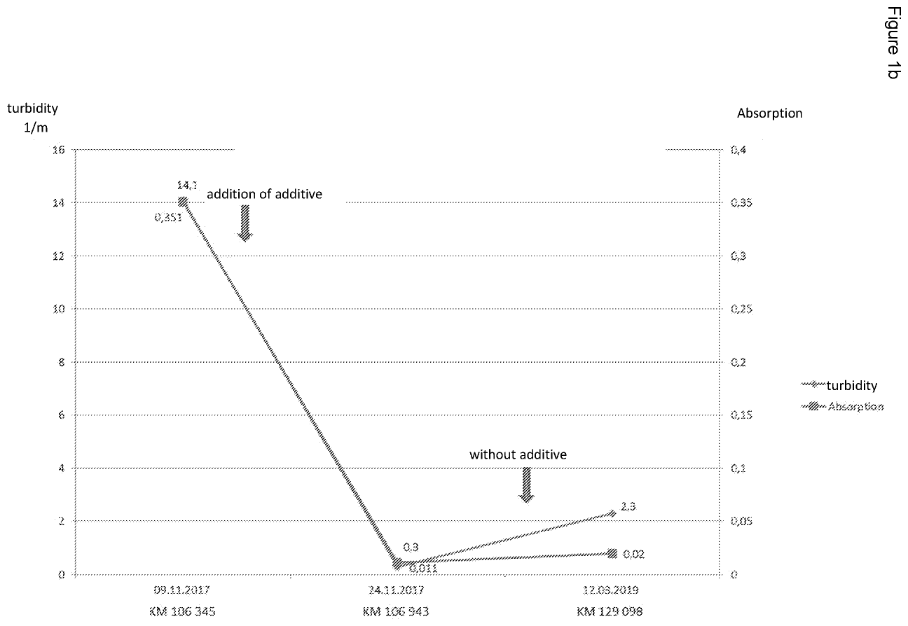

In FIGS. 1a and 1b, the results of the measuring of turbidity are depicted in 1/m and of absorption in %. It was measured according to the official German measuring process for the emissions test. Both the turbidity and the absorption are a measure for the number of carbon black particles in the exhaust gas. Based on a starting turbidity of 14.1 1/m, a reduction to 1 1/m could be achieved by the soaking of the air filter with citric acid polymerisate corresponding to the method according to the invention. The additional addition of glyoxal solution led to a further reduction to 0.3 1/m. As the results show, reductions of the pollutant emissions being unknown up until now can thus be achieved with the method according to the invention, in particular with using of the combination of citric acid polymerisate with glyoxal. Reductions of the particulates of approximately 100% were obtained. As FIG. 1b shows, the improvement persisted for more than one year even without further addition.

### EXAMPLE 3

In a second experiment on a VW Touareg R50, at first 100 ml of a 40% glyoxal solution was placed in the two air filters (before km 148,706). Moreover, according to the invention, 100 ml of a 50% citric acid polymerisate solution was placed in the two air filters. With a tankful of 80 l diesel, the addition of 100 ml glyoxal solution and 100 ml citric acid polymerisate solution corresponds to an additive amount of 0.5 per mille in one litre of diesel. Before the 4th test, there was 0.65 per mille active substance per 1 l diesel (tankful 76 l diesel), wherein it is assumed that only a fraction reaches the combustion chamber via the suction tract, probably in the microgram range.

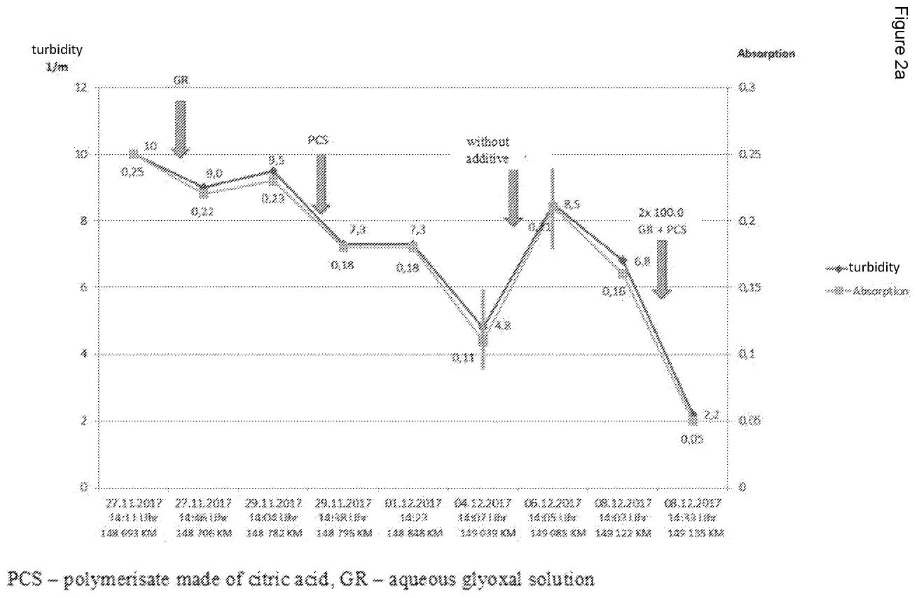

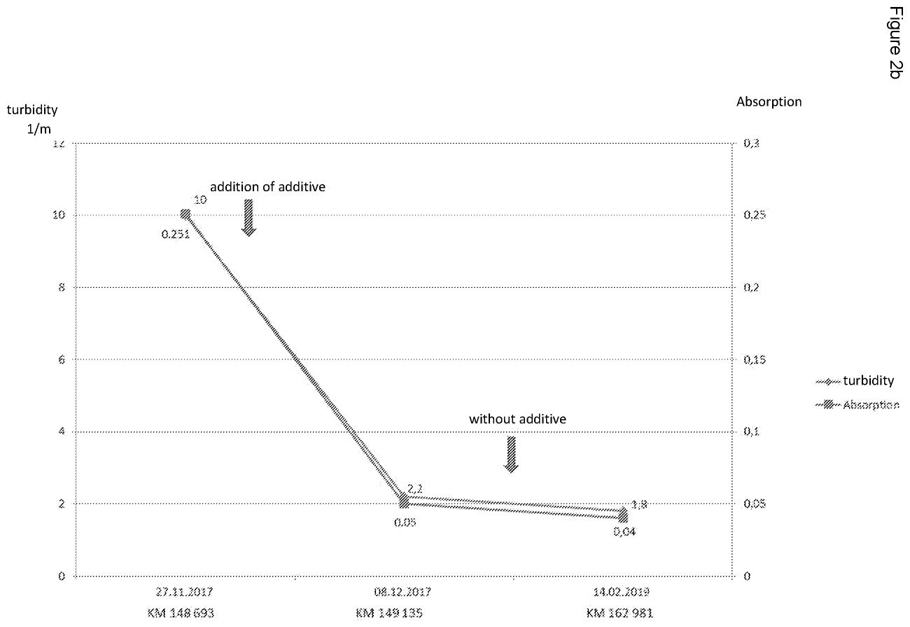

The measured values for turbidity and absorption are depicted in FIGS. 2a and 2b. It is recognised that, once again, very significant pollutant reductions were achieved. With the addition of glyoxal solution alone that took place as a comparison, a reduction of turbidity from 10 1/m to 9 1/m resulted. The additional addition of citric acid polymerisate solution obtained a decrease to 4.8 1/m. However, it is assumed that, when adding the citric acid polymerisate, the glyoxal was already used up (increase of the turbidity to 9.5 1/m at kilometre 148,782). The addition of the combination of glyoxal and citric acid polymerisate solution before kilometre 149,135 led to a drastic reduction of the turbidity to 2.2 1/m. FIG. 2b shows that the values even improved over more than one year without any further addition.

The particulates with diesel engines consist of a considerable amount of carbon black, an energy carrier, which is therefore not used. The extreme decrease of the unburnt material in purely mathematical terms leads to the conclusion of a consumption reduction. Evidence regarding this could be found in empirical values of 7 different motor vehicles (BMW 530 Diesel, BMW 750 12-Cylinder, 3 Audi A6 Diesel of various classes, Mini Cooper D, VW Touareg R50). Consumption reductions of 12.5 to 20% were found, depending on the driving mode and motor vehicle, from which, in turn, a reduction of the CO₂ emissions and, as a result of the added supply of energy carrier, here coal dust, a power increase can be deduced.

It is proven that glyoxal as fuel additive reduces the emission of CO₂, hydrocarbons, and NOₓ, and decreases consumption, too. This also happens when supplying it as component of the additive according to the invention. In the preferred embodiment, where the additive consists of an aqueous solution of glyoxal and citric acid polymerisate, also a synergistic reduction of particulates emission, consumption, and emission of CO, hydrocarbons, and nitrous oxides is achieved by one single additive. Problems of phase separation and demixing, which occurred for the known addition to fuel are not to be expected in the case of aqueous solutions.

1. Method for reducing the pollutant emissions from combustion engines, comprising providing an aqueous solution containing a polymer product of citric acid and glycerine as an additive and supplying the additive to a combustion chamber of the combustion engine.

2. Method according to claim 1, wherein the additive further contains glyoxal.

3. Method according to claim 2, wherein the additive is injected directly into the combustion chamber by a high-pressure pump system.

4. Method according to claim 3, wherein a volume ratio of glyoxal to polymer product of citric acid and glycerine ranges from 10:1 to 1:1.

5. Method according to one of claim 2, wherein the cooling requirement of the combustion engine is regulated by varying an amount of water of the additive.

6. Method according to claim 2, wherein the additive is introduced into a suction tract of the combustion engine.

7. Method according to claim 6, wherein a volume ratio of glyoxal to polymer product of citric acid and glycerine ranges from 1:10 to 1:1.

8. Method according to claim 1, characterised in that an aqueous glyoxal solution is supplied directly into the combustion chamber and the additive is supplied into a suction tract of the combustion engine.

9. Method according to claim 8, wherein the aqueous glyoxal solution is injected into the combustion chamber by a high-pressure pump system and the additive is evaporated in the suction tract via an air filter being soaked with it.

10. Additive for reducing the pollutant emissions of combustion engines consisting of an aqueous solution containing a polymer product of citric acid and glycerine.

11. Additive for reducing the pollutant emissions of a combustion engine consisting of an aqueous solution containing glyoxal and a polymer product of citric acid and glycerine.

12. Additive according to claim 11, characterised in that a volume ratio of glyoxal to polymer product of citric acid and glycerine for a direct injection into a combustion chamber of the combustion engine ranges from 10:1 to 1:1.

13. Additive according to claim 11, characterised in that a volume ratio of glyoxal to polymer product of citric acid and glycerine for an introduction into a suction tract of the combustion engine ranges from 1:10 to 1:1.

14. (canceled)

15. (canceled)

16. (canceled)

17. Method according to claim 1, wherein the additive is injected directly into the combustion chamber by a high-pressure pump system.

18. Method according to claim 17, wherein a cooling requirement of the combustion engine is regulated by varying an amount of water of the additive.

19. Method according to claim 1, wherein the additive is introduced into a suction tract of the combustion engine.

20. Method according to claim 19, wherein the additive is evaporated in the suction tract via an air filter being soaked with it.

21. Method according to claim 8, wherein the aqueous glyoxal solution is supplied directly into the combustion chamber and the additive is supplied into a suction tract of the combustion engine.

22. Method according to claim 2, wherein an aqueous glyoxal solution is injected into the combustion chamber by a high-pressure pump system and the additive is evaporated in a suction tract of the combustion engine via an air filter being soaked with it.
